(19) United States
(12) Patent Application Publication
(10) Pub. No.: US 2018/0017080 A1
(43) Pub. Date: Jan. 18, 2018

(54) VARIABLE STATOR VANE MECHANISM

(71) Applicant: ROLLS-ROYCE plc, London (GB)

(72) Inventor: Edward A. WALTERS, Derby (GB)

(73) Assignee: ROLLS-ROYCE plc, London (GB)

(21) Appl. No.: 15/626,796

(22) Filed: Jun. 19, 2017

(30) Foreign Application Priority Data
Jul. 18, 2016 (GB) 1612398.6

(51) Int. Cl. F04D 29/56; F02C 7/042; F04D 29/52

(52) U.S. Cl. CPC F04D 29/563; F04D 29/522; F02C 7/042; F05D 2240/12; F05D 2260/50; F05D 2220/32

(57) ABSTRACT

A variable vane mechanism for adjusting the angle of stator vanes in a gas turbine engine is provided. The mechanism has a circumferentially extending drive ring that is driven by an actuator, and a guide surface that is radially inside the drive ring. The mechanism also has a centralising pin that is connected to the drive ring and also in slidable contact with the guide surface so as to be movable with the drive ring relative to the guide surface. The centralising pin allows both the drive ring to be connected to a stator vane (via a lever) in order to adjust the angle of the vane, and the radial position of the drive ring to be adjusted to ensure accurate and repeatable operation of the mechanism.

### CROSS-REFERENCE TO RELATED APPLICATIONS

This specification is based upon and claims the benefit of priority from UK Patent Application Number 1612398.6 filed on Jul. 18, 2016, the entire contents of which are incorporated herein by reference.

### BACKGROUND

### 1. Field of the Disclosure

This disclosure relates to a mechanism for a variable stator vane such as a variable inlet guide vane.

### 2. Description of the Related Art

In a gas turbine engine having a multi-stage axial compressor, the turbine rotor is turned at high speed so that air is continuously induced into the compressor, accelerated by the rotating blades and swept rearwards onto an adjacent row of stator vanes. Each rotor-stator stage increases the pressure of the air passing through the stage and at the final stage of a multistage compressor the air pressure may be many times that of the inlet air pressure.

In addition to converting the kinetic energy of the air into pressure the stator vanes also serve to correct the deflection given to the air by the rotor blades and to present the air at the correct angle to the next stage of rotor blades.

As compressor pressure ratios have increased it has become more difficult to ensure that the compressor will operate efficiently over the operational speed range of the engine. This is because the inlet to exit area ratios of the stator vanes required for high pressure operation can result in aerodynamic inefficiency and flow separation at low operational speeds and pressures.

In applications where high pressure ratios are required from a single compressor spool the above problem may be overcome by using variable stator vanes. Variable stator vanes permit the angle of incidence of the exiting air onto the rotor blades to be corrected to angles which the rotor blades can tolerate without flow separation.

The use of variable stator vanes permits the angle of one or more rows of stator vanes in a compressor to be adjusted, while the engine is running, for example in accordance with the rotational speed and mass flow of the compressor.

The term variable inlet guide vane (VIGV) used herein refers specifically to vanes in the row of variable vanes at the entry to a compressor. The term variable stator vane (VSV) used herein refers generally to the vanes in the one or more rows of variable vanes in the compressor which may include a VIGV row. A function of such VIGVs or VSVs may be to improve the aerodynamic stability of the compressor when it is operating at relatively low rotational speeds at off-design, i.e. non-optimum speed, conditions.

At low speed and mass flow conditions, the variable vanes may be considered to be in a “closed” position, directing and turning the airflow in the direction of rotation of the rotor blades immediately downstream. This reduces the angle of incidence at entry to the blades and hence the tendency of them to stall. As the rotational speed and mass flow of the compressor increases with increasing engine power, the vanes are moved progressively and in unison towards what may be considered to be an “open” position.

The movement is controlled such that the flow angle of the air leaving the stator vanes continues to provide an acceptable angle of incidence at entry to the downstream row of rotor blades. When the vanes are in the fully “open” position, the angles of all of the stator vanes and rotor blades will typically match the aerodynamic condition at which the compressor has been designed i.e. its “design point”.

In order to adjust the angle of incidence of the VSVs, a variable vane mechanism may be provided in which linear movement of an actuator turns a ring (which may be referred to as a unison ring) which encircles the engine. This ring is linked to the vanes via levers and pins. Hence as the actuator moves, its linear motion translates into turning of the vanes about their longitudinal axis, thereby changing their angle of incidence.

In order for such a mechanism to be effective and accurate, the unison ring must be kept concentric with the rest of the engine. Deflection or eccentricity of the ring affects the operation and/or accuracy of the mechanism. Accordingly, dedicated centralising mechanisms have been proposed in order to centralise the ring.

However, such dedicated centralising mechanisms, provided as separate parts, add weight and cost to the engine. Furthermore, the location and number of the dedicated centralising mechanisms must be fixed during the design of the engine, so as to ensure that they do not clash and/or interfere with other parts of the mechanism or engine. Accordingly, if engine development testing reveals poor accuracy and/or repeatability of the VSV mechanism, then it is likely that the entire mechanism will need to be redesigned and manufactured. Still further, if the stator row comprises a large number of stator vanes and/or a low separation between stator vanes, then there may be insufficient space to accommodate conventional dedicated centralising mechanisms.

Accordingly, it is desirable to provide an improved variable stator vane arrangement, for example having lower cost and/or weight, and/or greater design flexibility and/or greater accuracy and/or repeatability.

### SUMMARY

According to an aspect, there is provided a variable vane mechanism for adjusting the angle of stator vanes in an axial flow gas turbine engine that defines axial, radial and circumferential directions, the variable vane mechanism comprising:
a circumferentially extending drive ring arranged to be driven circumferentially by a drive mechanism;
a circumferentially extending guide surface that is radially inside the drive ring;
a centralising pin that is connected to the drive ring so as to move with the drive ring, a first end of the centralising pin being in slidable contact with the guide surface so as to be movable relative to the guide surface; and
a lever having a first end and a second end, the first end being rotatably connected to the centralising pin so as to be moveable with the centralising pin and rotatable relative to the centralising pin, and the second end being arranged for connection to a stator vane so as to enable adjustment of the angle of the stator vane.

The circumferentially extending guide surface may be said to be radially offset from the drive ring and/or concentric with the drive ring. The first end of centralising pin may remain in contact with guide surface during movement. The lever may be said to be rotatable relative to the centralising pin about a substantially radial direction. The centralising pin may be said to perform the function of both ensuring the correct position of the mechanism (for example the correct radial position of drive ring, for example that the drive ring is concentric with the rest of the engine (including, for example, the guide surface), for example that the drive ring is in the correct position relative to the guide surface) and transferring the drive from the drive ring to the lever. The variable vane mechanism may solve at least one or more of the problems discussed herein in relation to conventional mechanisms.

The terms axial, radial and circumferential as used herein may be relative to a gas turbine engine in which the variable vane mechanism may be used. Additionally or alternatively, the terms axial, radial and circumferential may be defined by the drive ring and/or guide surface themselves. The axial, radial and circumferential directions may be the same regardless of whether they are defined by the gas turbine engine or the drive ring and/or guide surface.

The centralising pin may extend in a substantially radial direction and/or perpendicularly to the drive ring and/or guide surface.

The centralising pin may extend through the drive ring. The drive ring may comprise a through-hole (for example a radially extending through hole) through with the centralising pin extends.

The centralising pin may comprise a thread. The drive ring may comprise a thread, which may correspond with (for example complement) that of the centralising pin, The thread of the drive ring may engage with the thread of the centralising pin. The threads may be formed around a substantially radial axis. The relative radial position of the drive ring and the first end of the centralising pin may be adjusted using the threads. For example, screwing one thread in one direction may increase the radial separation of the drive ring and the first end of the centralising pin, whereas screwing the thread in the other direction may decrease the radial separation of the drive ring and the first end of the centralising pin.

The centralising pin may have an external thread. The drive ring thread may be an internal thread, for example formed in a through-hole through the drive ring.

The variable vane mechanism may further comprise a lock nut for fixing the radial position of the drive ring relative to the first end of the centralising pin. Accordingly, once the radial position of the drive ring has been set, it may be locked in position by a locking mechanism, such as a lock nut.

Such a lock nut, where present, may be in threaded engagement with the thread of the centralising pin. The lock nut may engage a surface of the drive ring (for example a radially outer surface of the drive ring), thereby locking the drive ring and the centralising pin together.

The first end of the centralising pin may comprise a foot having an engagement portion shaped to correspond with the guide surface. Such an engagement portion may be arranged to slide across the guide surface in use whilst remaining in contact with the guide surface.

The guide surface may be provided with a coating that has a lower coefficient of friction than the rest of a component that forms the guide surface. The first end of the centralizing pin (for example an engagement portion of a foot) may be provided with a coating that has a lower coefficient of friction than the rest of the centralizing pin.

The variable vane mechanism may further comprise a drive pin. Such a drive pin may be connected to the drive ring so as to move with the drive ring. The variable vane mechanism may further comprise a further lever having a first end rotatably connected to the drive pin so as to be moveable with the drive pin and rotatable relative to the drive pin, and the second end being arranged for connection to a stator vane so as to enable adjustment of the angle of the stator vane. The drive pin is not in contact with the guide surface. The drive pin and the centralising pin may be substantially the same (for example in terms of construction and/or function) other than in that the centralising pin is in slidable contact with the guide surface whereas the drive pin is not. Some variable stator vanes may be driven by (i.e. have their angle of incidence determined by) a drive pin, and other variable stator vanes may be driven by (i.e. have their angle of incidence determined by) a centralising pin. A variable vane mechanism may comprise one or more centralising pins. Optionally, a variable vane mechanism may comprise one or more drive pins.

In variable vane mechanisms comprising both centralising pins and drive pins, they may be interchangeable. Thus, for example, it may be possible to replace a drive pin with a centralising pin, for example if it is concerned that the drive ring requires greater support and/or adjustability to remain concentric. For example the mechanisms by which the centralising pins and drive pins are attached to the drive ring may be the same and/or compatible and/or interchangeable.

The guide surface may be a radially outer surface of a casing of a gas turbine engine, for example a radially outer surface of a compressor casing.

According to an aspect, there is provided a variable vane drive arrangement comprising:
a variable vane mechanism as described and/or claimed herein; and
an actuator connected to the drive ring such that the drive ring can be moved circumferentially by the actuator.

The actuator may be able to drive the drive ring in both a clockwise and anti-clockwise direction. The drive ring may be said to be rotated around an axial direction by the actuator. Circumferential (or rotational) movement of the drive ring about a substantially axial direction may then be converted to rotational movement of the stator vanes about a substantially radial direction by the variable vane mechanism.

In general, the rotation of the variable stator vanes may be said to be about a substantially radial direction and/or about a substantially longitudinal or spanwise direction of the vane.

Such an actuator may be a linear actuator. Such a linear actuator may be connected to the drive ring via a hinge. The hinge may allow the linear movement of the actuator to drive circumferential movement of the drive ring.

The drive ring and/or the guide surface may extend around a full circumference or part circumference. There may be more than one drive ring and/or guide surface for a given stator row. Where more than one of either is provided, each may extend around a circumferential segment. Where more than one drive ring is provided, each may be provided with dedicated actuator.

According to an aspect, there is provided a stator vane row of a gas turbine engine comprising a variable vane drive arrangement as described and/or claimed herein. The stator vane row also comprises a plurality of variable stator vanes. Each stator vane may be connected to the second end of a respective lever. Each stator vane may be rotated about a substantially radial direction under the action of the actuator.

Each stator vane may be rigidly connected to (or fixed to) the second end of the lever. Each stator vane may be connected to the second end of the lever such that there are no degrees of freedom between the lever and the stator vane and/or such that they move together as a single rigid body.

There may, of course, be more than one variable stator vane. Each variable stator vane may be connected to a lever that is connected to a centralising pin or (where present) a drive pin, as described and/or claimed elsewhere herein.

According to an aspect, there is provided a gas turbine engine comprising at least one stator vane row as described and/or claimed herein. At least one such stator vane row may be a compressor stator vane row, such as a variable inlet guide vane (VIGV). Such a gas turbine engine may be any type of gas turbine engine, including, by way of example only, a turbofan gas turbine engine.

According to an aspect, there is provided a method of operating a gas turbine engine comprising a variable stator van row as described and/or claimed herein. The method of operation may comprise adjusting the angle of the variable stator vanes (for example using a variable vane mechanism as described and/or claimed herein) based on the operating condition of engine.

The skilled person will appreciate that except where mutually exclusive, a feature described in relation to any one of the above aspects may be applied to any other aspect. Furthermore except where mutually exclusive any feature described herein may be applied to any aspect and/or combined with any other feature described herein.

### BRIEF DESCRIPTION OF THE DRAWINGS

Embodiments will now be described by way of example only, with reference to the Figures, in which:

FIG. 1 is a sectional side view of a gas turbine engine on accordance with the present disclosure;

FIG. 2 is a schematic perspective view of part of a stator vane row in accordance with an example of the present disclosure;

FIG. 3 is a schematic perspective view of part of a variable vane mechanism in accordance with an aspect of the present disclosure;

FIG. 4 is a schematic cross-sectional view of part of a variable vane mechanism in accordance with an aspect of the present disclosure; and

FIG. 5 is a schematic cross-sectional view of a centralising pin in accordance with an aspect of the present disclosure.

### DETAILED DESCRIPTION OF THE DISCLOSURE

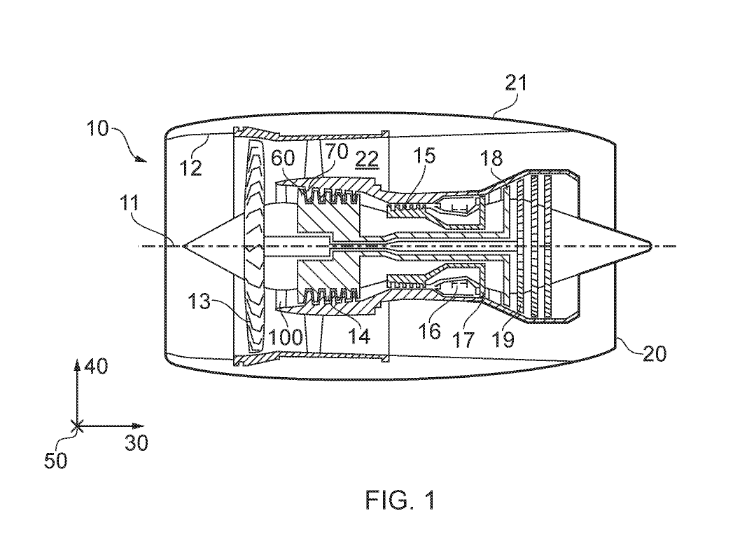

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

At least one of the compressors 14, 15 and the turbines 17, 18, 19 comprise stages having rotor blades in rotor blade rows (labelled 60 by way of example in relation to the intermediate pressure compressor in FIG. 1) and stator vanes in stator vane rows (labelled 70 by way of example in relation to the intermediate pressure compressor in FIG. 1).

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan. Further, the engine may not comprise a fan 13 and/or associated bypass duct 22 and/or nacelle 21. Whilst the described example relates to a turbofan engine, the disclosure may apply, for example, to any type of gas turbine engine, such as a turbojet or turboprop engine, for example.

The geometry of the gas turbine engine 10, and components thereof, is defined by a conventional axis system, comprising an axial direction 30 (which is aligned with the rotational axis 11), a radial direction 40, and a circumferential direction 50 (shown perpendicular to the page in the FIG. 1 view). The axial, radial and circumferential directions 30, 40, 50 are mutually perpendicular.

Any one of the stator vane rows 70 in the gas turbine engine 10 may be a variable stator vane (VSV) row. Such a variable stator vane row 70 comprises a variable vane mechanism that allows the angle of the vanes 70 (for example the angle of incidence of the vanes 70) to be adjusted in use. Purely by way of example, the gas turbine engine 10 shown in FIG. 1 has a VSV row at the inlet to the core of the engine in the form of a variable inlet guide vane (VIGV) row 100.

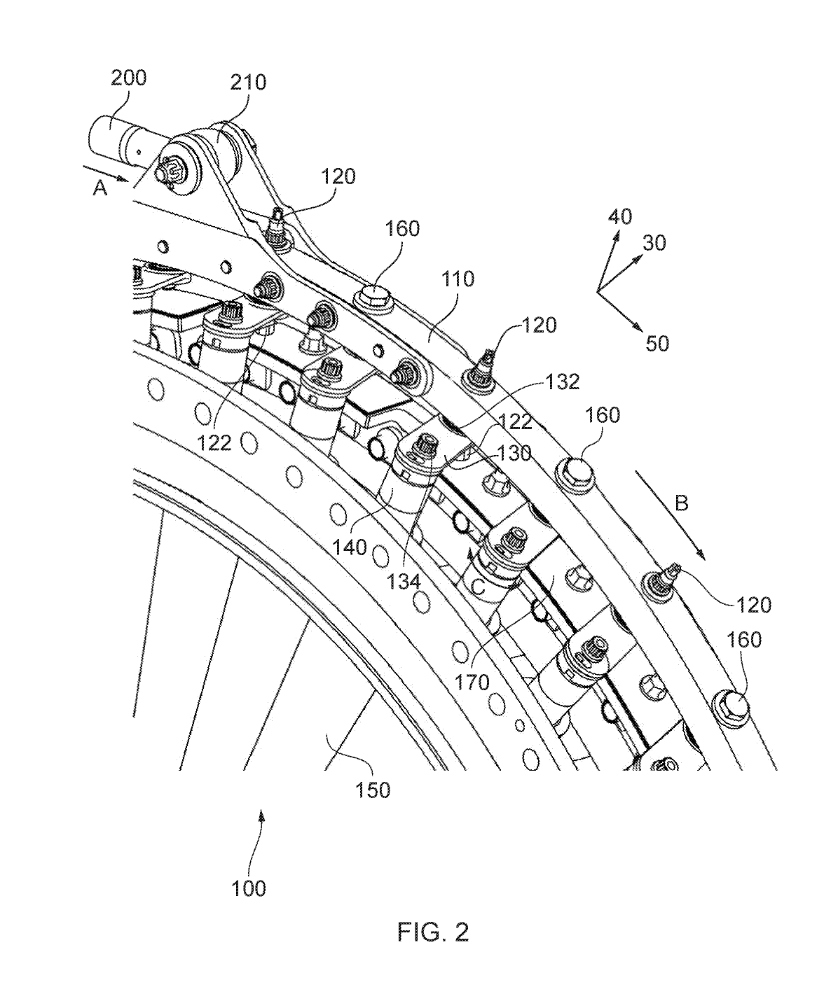

FIG. 2 shows a part of the VSV (or VIGV) row 100 in greater detail, including a variable vane mechanism. The VSV 100 comprises variable stator vanes 150. The angle of the variable stator vanes 150 may be adjusted during use. In order to vary the angle of the stator vanes 150, an actuator 200 may be used, which may be a linear actuator as in the FIG. 2 example. The actuator 200 is connected to a drive ring 110 via a joint (which may be a hinge) 210. The joint 210 may allow rotation of the drive ring 110 relative to the actuator 200, for example about an axial direction running through the joint. This may be particularly suitable for arrangement having a linear actuator.

Movement of the actuator 200 (which may be, for example, based on a control signal which may in turn be based on an engine operating condition and/or thrust demand) causes the drive ring 110 to rotate about the axial direction 30. In the FIG. 2 example, linear movement A of the actuator 200 is converted into circumferential movement B of the drive ring 110.

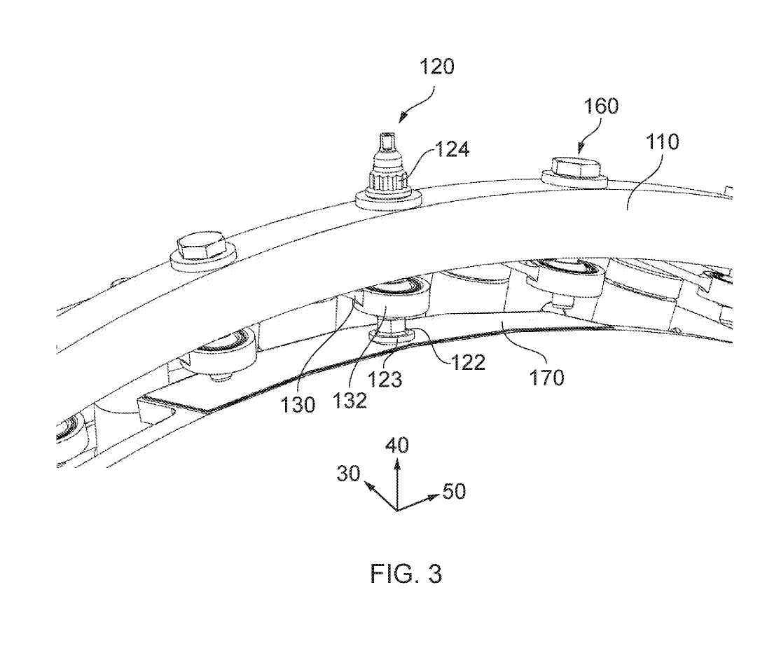

The drive ring 110 has at least one centralising pin 120 connected thereto. The centralising pin 120 (shown in more detail in FIGS. 3, 4 and 5) is rigidly connected to the drive ring 110 such that the drive ring 110 and the centralising pin 120 move together. The centralising pin 120 is connected to a first end 132 of a lever 130. The first end 132 of the lever 130 therefore moves with the centralising pin 120, but may rotate relative to it about a longitudinal axis of the centralising pin 120.

A second end 134 of the lever 130 may be separated from the first end 132 in a direction that has at least a component (for example a major component) in the axial direction 30.

The second end 134 may be spaced from the first end 132 in a substantially axial direction 30. The second end 134 of the lever 130 is connected (for example rigidly connected) to a vane 150. The second end 134 may, for example, be connected to a spindle 140 that extends from a vane 150, as in the FIG. 2 example. The second end 134 of the lever may be rigidly fixed in the axial 30, radial 40 and circumferential 50 directions, but may be rotatable about a radial direction 40, as indicated by the arrow C in FIG. 2.

Accordingly, the circumferential movement B of the drive ring 110 (which may be described as rotation about the axial direction 30) may be converted into rotation C of the vane 150 about a substantially radial direction 40. This may be achieved by the centralising pin 120 and the lever 130.

In order to ensure that the VSV arrangement 100 is reliable (for example accurate and/or repeatable) the drive ring 110 must be kept concentric with the rest of the arrangement. In order to achieve this, a first end 122 of the centralising pin 120 is in slidable contact with a guide surface 170. In use, the guide surface 170 remains stationary, and the first end 122 of the centralising pin 120 slides across, and remains in contact with the guide surface 170.

Accordingly, the position (for example at least the radial position) of the drive ring 110 relative to the guide surface 170 may be determined and/or maintained by the centralising pin 120. The guide surface 170 may be rigidly attached and/or an integral part of the gas turbine engine 10. For example, the guide surface 170 (which may be said to be a surface that is perpendicular to the radial direction and/or extends in a circumferential direction and/or a cylindrical surface) may be a part of a casing, such as a compressor casing, of the gas turbine engine 10.

The drive ring 110, centralising pin 120, lever 130 and guide surface 170 may together be referred to as a variable vane mechanism. This variable vane mechanism in combination with the actuator 200 may be referred to as a variable vane drive arrangement.

FIGS. 3, 4 and 5 show aspects of the variable vane mechanism and variable vane drive arrangement in greater detail. The first end 122 of the centralising pin 120 may be provided with a foot, or guide foot, 123, as in the arrangement of FIGS. 3, 4 and 5. A foot 123 may be provided in any suitable manner, for example via a thread. In such arrangements, the foot 123 is the part of the centralising pin 120 that is in contact with, and slides across, the guide surface 170. The foot 123 may have an engagement portion 128 that engages with the guide surface 170. The engagement portion 128 may be shaped to correspond to the guide surface 170, for example by being a segment of a cylindrical surface. The foot 123 and the guide surface 170 may have a surface finish that has a low coefficient of friction,

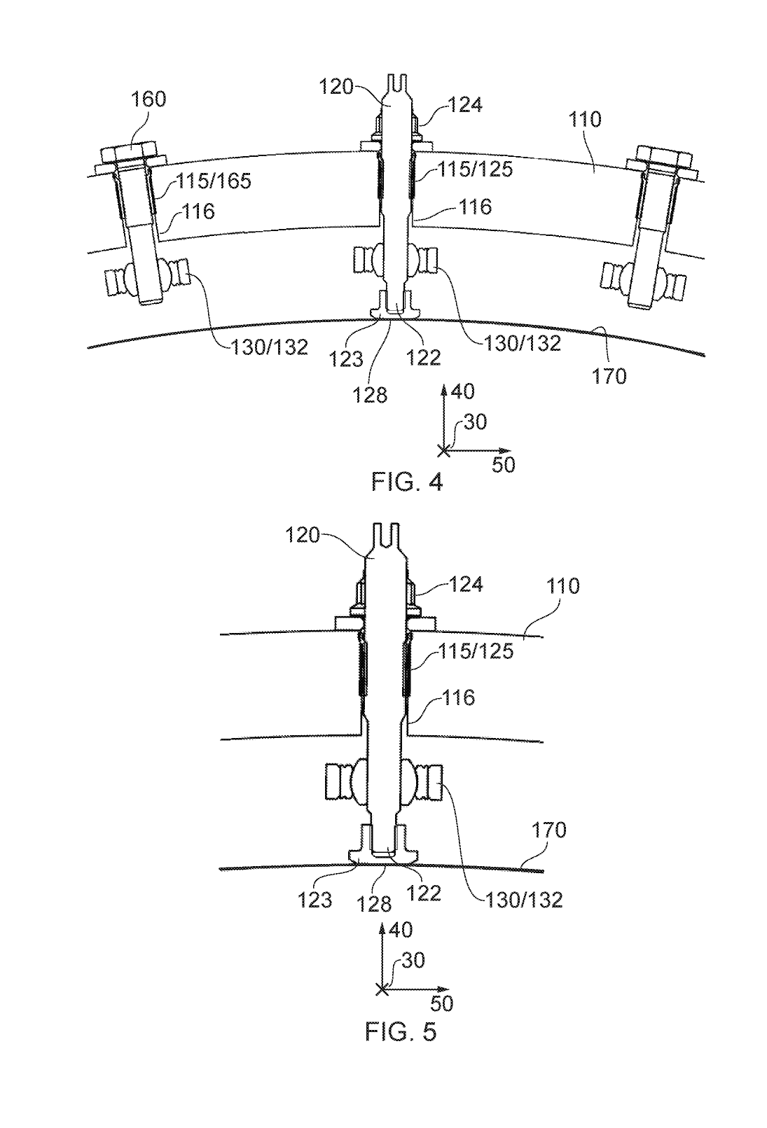

As seen most easily in FIGS. 4 and 5, the centralising pin 120 may be provided to the drive ring 110 by extending (for example in a radial direction 40) through a bore 116 in the drive ring 110. At least a part of the bore 116 may be provided with an internal thread 115, as in the illustrated examples. The centralising pin 120 may be provided with an external thread 125 that corresponds with (for example has the same diameter and pitch) the internal thread 115 of the bore 116, Accordingly, the centralising pin 120 may be moved (for example in a radial direction 40) relative to the drive ring 110 by turning the centralising pin 120 about a radial direction such that the threads 115, 125 move across each other, in this way, the drive ring 110 may be moved, at least radially, relative to the guide surface 170. This may allow the drive ring 110 to be centralised with respect to the rest of the engine 10 and/or vane row 70/100, for example to ensure that it is concentric with the rest of the engine 10 and/or vane row 70/100. One or more, for example a plurality of (for example at least 2, 5, 10, 15, 20 or more than 20), centralising pins 120 may be provided as required in order to provide sufficiently fine adjustment of the position of the drive ring 110 relative to other parts of the engine 10, such as the guide surface 170.

Once the desired position of a given centralising pin 120 has been determined (for example by turning the thread 125 in the thread 115 of the bore 116), it may be locked in position in any suitable manner. For example, a lock nut 124 may be provided for this purpose, as in the illustrated example.

Some of the vanes 150 in the row 70/100 may be connected to the drive ring 110 by drive pins 160, rather than centralising pins 120, as shown in FIGS. 2, 3 and 4. The drive pin 160 is substantially the same as the centralising pin 120, other than in that it is not in contact with the guide surface 170. Thus, the drive pins 160 can be used to transfer the rotational movement to a vane 150, but cannot be used to adjust the position of the drive ring 110. A drive pin 160 may be connected to the drive ring 110 in the same manner as that used to connect a centralising pin 120 to the drive ring 110. Thus, as shown in the FIG. 4 example, a drive pin 160 may be provided with an external thread 165 that engages with the internal thread 115 of a bore 116 in the drive ring 110. The thread 165 of the drive pin 160 may be the same as the thread 125 of the centralising pin 120. Accordingly if, for example, during development and/or service of a variable stator vane row 70/100 it is determined that an additional centralising pin 120 is required, it can be added simply by unscrewing a drive pin 160 and replacing it with a centralising pin 120.

In the example shown in FIGS. 2, 3 and 4, every other pin is a centralising pin 120, with the remainder being drive pins 160. However, it will be appreciated that any combination of centralising pins 120 and drive pins 160 may be used, and that, for example, some variable vane mechanisms may comprise all centralising pins 120, and no drive pins 160.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A variable vane mechanism for adjusting the angle of stator vanes in an axial flow gas turbine engine that defines axial, radial and circumferential directions, the variable vane mechanism comprising:
a circumferentially extending drive ring arranged to be driven circumferentially by a drive mechanism;
a circumferentially extending guide surface that is radially inside the drive ring;
a centralising pin that is connected to the drive ring so as to move with the drive ring, a first end of the centralising pin being in slidable contact with the guide surface so as to be movable relative to the guide surface; and
a lever having a first end and a second end, the first end being rotatably connected to the centralising pin so as to be moveable with the centralising pin and rotatable relative to the centralising pin, and the second end being arranged for connection to a stator vane so as to enable adjustment of the angle of the stator vane.

2. A variable vane mechanism according to claim 1, wherein the centralising pin extends in a substantially radial direction.

3. A variable vane mechanism according to claim 1, wherein the centralising pin extends through the drive ring.

4. A variable vane mechanism according to claim 1, wherein the centralising pin comprises a thread that engages with a corresponding thread of the drive ring, the threads being formed around a substantially radial axis such that the relative radial position of the drive ring and the first end of the centralising pin can be adjusted using the threads.

5. A variable vane mechanism according to claim 1, further comprising a lock nut for fixing the radial position of the drive ring relative to the first end of the centralising pin.

6. A variable vane mechanism according to claim 5, wherein the centralising pin comprises a thread that engages with a corresponding thread of the drive ring, the threads being formed around a substantially radial axis such that the relative radial position of the drive ring and the first end of the centralising pin can be adjusted using the threads, and wherein the lock nut in threaded engagement with the thread of the centralising pin, and engages a surface of the drive ring, thereby locking the drive ring and the centralising pin together.

7. A variable vane mechanism according to claim 1, wherein the first end of the centralising pin comprises a foot having an engagement portion shaped to correspond with the guide surface, the engagement portion being arranged to slide across the guide surface in use.

8. A variable vane mechanism according to claim 1, wherein the guide surface is provided with a coating that has a lower coefficient of friction than the rest of a component that forms the guide surface and/or the first end of the centralizing pin is provided with a coating that has a lower coefficient of friction than the rest of the centralizing pin.

9. A variable vane mechanism according to claim 1, further comprising a drive pin, wherein:
the drive pin is connected to the drive ring so as to move with the drive ring;
the variable vane mechanism further comprises a further lever having a first end rotatably connected to the drive pin so as to be moveable with the drive pin and rotatable relative to the drive pin, and a second end being arranged for connection to a stator vane so as to enable adjustment of the angle of the stator vane; and
the drive pin is not in contact with the guide surface.

10. A variable vane mechanism according to claim 1, wherein the guide surface is a radially outer surface of a casing of a gas turbine engine.

11. A variable vane drive arrangement comprising:
a variable vane mechanism according to claim 1; and
an actuator connected to the drive ring such that the drive ring can be moved circumferentially by the actuator.

12. A variable vane drive arrangement according to claim 11, wherein the actuator is a linear actuator that is connected to the drive ring via a hinge that allows the linear movement of the actuator to drive circumferential movement of the drive ring.

13. A stator vane row of a gas turbine engine comprising:
a variable vane drive arrangement according to claim 11; and
a plurality of variable stator vanes each connected to the second end of a respective lever such that the stator vanes can be rotated about a substantially radial direction under the action of the actuator.

14. A gas turbine comprising a stator vane row according to claim 13.

15. A method of operating a gas turbine engine according to claim 14, comprising adjusting the angle of the variable stator vanes based on the operating condition of engine.
